(19) United States
(12) Patent Application Publication
(10) Pub. No.: US 2015/0061541 A1
(43) Pub. Date: Mar. 5, 2015

(54) LIGHTING SYSTEM INCLUDING NEAR FIELD COMMUNICATION CONTROLLER

(71) Applicant: Nicola Gandini, Valeggio sul Mincio (Verona) (IT)

(72) Inventor: Nicola Gandini, Valeggio sul Mincio (Verona) (IT)

(21) Appl. No.: 14/470,208

(22) Filed: Aug. 27, 2014

Related U.S. Application Data
(60) Provisional application No. 61/871,156, filed on Aug. 28, 2013.

(51) Int. Cl. H05B 37/02; A01K 63/06; A01K 29/00; A01K 63/04

(52) U.S. Cl. CPC H05B 37/0272; H05B 37/0281; A01K 63/04; A01K 63/065; A01K 63/06; A01K 29/00
USPC 315/294

(57) ABSTRACT

An environmental control system such as an illumination system includes one or more LED lighting devices or other environmental factor control devices and a control device for controlling one or a combination of the LED lighting devices or other environmental factor control devices. A remote controller for remotely setting control content, control parameters and the like can be communicatively coupled (e.g., wirelessly) to the control device. The remote controller can be a smartphone or other device that includes an LED lighting control or other environmental control module or unit for setting one or more properties or parameters of a control target lighting/environmental device using near field communications. Properties and functions controlled by the remote controller can include timers, spectral content, intensity, etc. that are programmed by a user employing a simple application (e.g., featuring a GUI or other user-friendly interface).

### PRIORITY CLAIM

This application claims the benefit of U.S. Provisional Application No. 61/871,156, filed Aug. 28, 2013, the contents of which are hereby incorporated by reference in its entirety.

### BACKGROUND

The present disclosure relates to lighting systems that are controlled based on utilization of a near field communication (NFC) information transfer protocol.

Lighting systems include several types of light emitting devices. One example of a light emitting device is the light emitting diode (LED), which is currently used in a wide variety of lighting applications. LEDs provide a wide array of advantages over many other lighting systems and devices, a number of which are discussed in U.S. Pat. No. 7,473,008, issued to Orbitec and incorporated by reference herein in its entirety for all purposes. One exemplary application utilizing LEDs is with regard to aquarium lighting systems. With aquarium lighting systems, the lighting requirements are different than with other lighting systems, such as home illumination systems. Lighting systems, and more specifically LED lighting systems, have been developed that including the ability to individually control output parameters of the LEDs, and include the ability to provide optimal spectral output for sustenance and growth of marine life by controlling said output parameters. For example, with aquarium lighting systems, it can be beneficial to simulate the natural cycle of the sun. This can include increasing the light level gradually in the morning, and decreasing the light level gradually in the night. Other options for aquarium lighting systems include controlling the lighting to simulate the presence of the moon, to simulate the spectral variation of sunlight during different periods of the day, and to create different patterns of light with different color combinations of LEDs.

Certain existing lighting systems utilize processors, display devices (e.g., an LCD screen), and input devices such as buttons or touch screens on the actual lighting unit itself to enable a user to make changes to the parameters of the lighting system. As an alternative to a direct input device such as a button or touch screen, hand held remote control devices may be included that are operatively coupled to the lighting system to enable a user to customize lighting settings without direct contact to the system. One such related system is discussed in U.S. Application Publication No. 2013/0141011 to Fushimi, which is incorporated by reference herein in its entirety for all purposes. However, because of the general complexity of the lighting system, and the wide variety of possible simulated lighting conditions discussed above, controlling such combinations of lighting elements to achieve the desired lighting effects by using a touch screen device or remote controller can be cumbersome and quite complicated for a user.

Moreover, in other lighting systems, control of the lighting elements may be performed on a personal computer that is directly connected to the lighting system. Such a personal computer also must typically be physically near the aquarium, which can present a user with another undesirable limitation on such a system's use. For example, certain existing lighting systems utilize a direct wired connection between the lighting system and an external hardware device such as a personal computer. Likewise, it can be complicated for a user to physically connect the lighting system to a computer via a USB interface, a TC/IP interface, or any other suitable type of wired interface. Therefore, such lighting system can be complex to install and to use.

Therefore, there is a need to overcome the disadvantages described above or otherwise lessen the effects of such disadvantages.

### SUMMARY

The present disclosure generally relates to environmental control system that is controlled based on near field communication. The environmental control system includes the ability to control a lighting system, temperature, humidity, salinity and other environmental factors that might be relevant to maintaining a favorable bio-environment for a given type of organism (e.g., terrestrial animals, terrestrial plant life, marine animals, marine plant life, etc.). The environmental control system, in one embodiment, includes a lighting system that includes a plurality of light emitting devices and a controller configured to control the lighting elements using information received via a near field communication channel.

In an embodiment, a lighting unit includes a plurality of light emitting devices, and a near field communication unit communicatively coupled with the light emitting devices. The near field communication unit is operable to receive lighting unit information from a remote control unit via near field communication, and to transmit lighting unit information to the remote control unit via near field communication.

In an embodiment, the light emitting devices are light emitting diodes.

In an embodiment, the lighting unit information includes control parameters for controlling the operation of at least one of the light emitting devices.

In an embodiment, the lighting unit information includes at least one selected from the group consisting of: lighting unit production data including at least one of a serial number, a manufacturing date, inspection information, and a production batch number; lighting unit distribution data including at least one of a customer name, a date of sale, and a sale price; and lighting emitting device parameters including at least one of light emitting device configuration, and light emitting device timing control information.

In an embodiment, the lighting unit further includes a memory storing at least a software program including executable instructions, and a processor configured to execute the instructions of the software program to cause at least one of: reading lighting unit information stored on the memory, and causing the lighting unit information to be transferred from the near field communication unit to the remote control unit; storing the lighting unit information received from the remote control unit on the memory; and setting an operating parameter of at least one of the light emitting devices based on the lighting information received from the remote control unit, or based on lighting information that has been stored on the memory.

In an embodiment, the lighting unit information includes parameters defining different operating states that can be applied to one or more of the light emitting devices.

In an embodiment, the operating states of the light emitting devices include at least one selected from the group consisting of spectral content, an on/off state, a light emission intensity level, and a rate of change of the light emission intensity level.

In an embodiment, the lighting unit information further includes a timing schedule for changing one or more of the operating states with regard to at least one of the light emitting devices. Other embodiments include selecting a lighting scheme applicable to particular geographical location to simulate environmental conditions in such a location (e.g., the Caribbean, the Mediterranean, the South Pacific, etc.). Other embodiment, include selecting a lighting scheme applicable to one or more types of biological life forms (e.g., different species of fish, reptiles, different types of plant life, etc.).

In another embodiment, a non-transitory computer-readable medium is provided storing executable instructions that when executed by a processor cause a computer to perform steps for executing a process, the process comprising at least one of: causing lighting unit information to be sent wirelessly from a remote control unit via near field communication to a lighting unit including a plurality of light emitting devices, and processing lighting unit information that is received wirelessly from the lighting unit via near field communication.

In another embodiment, a lighting system includes a lighting unit including a plurality of light emitting devices, and a first near field communication unit communicatively coupled with the light emitting devices. The lighting system further includes a remote control unit including a second near field communication unit and a non-transitory computer-readable medium storing executable instructions that when executed by a processor cause said remote control unit to perform at least one of the steps of causing first lighting system information to be sent wirelessly via near field communication from the second near field communication unit to the first near field communication unit, and processing second lighting system information that is received wirelessly via near field communication by the second near field communication unit and that was sent from the first near field communication unit.

In contrast to related art lighting systems that require a complicated physical or wireless connection to a personal desktop computer, or that require inconvenient LCD screens or push button remote control units, the present embodiments including the NFC control unit provide a simpler, more intuitive GUI based lighting system programming interface, and that simplifies the process of connecting the NFC control unit to the lighting unit.

Additional features and advantages are described herein, and will be apparent from the following Detailed Description and the figures.

### BRIEF DESCRIPTION OF THE FIGURES

FIG. 1 is a schematic illustration of a lighting system according to an embodiment.

FIG. 2 is an illustration of a screen display of a user interface that is installed on a computing device of one embodiment.

FIG. 3A is an illustration of a screen display of a near field control unit according to one embodiment, showing a first exemplary user interface.

FIG. 3B is an illustration of a screen display of a near field control unit according to one embodiment, showing a second exemplary user interface.

### DETAILED DESCRIPTION

The present embodiments relate to an environmental control unit including at least one of a lighting or illumination system, a temperature control system, a humidity control system, a fluid flow control system, a chemical composition control system (e.g., a water salinity control).

The lighting system includes a lighting unit, and an NFC control unit that is configured to remotely control the lighting unit via a near field communication channel. The lighting unit includes one or more light emitting devices, and a control device for controlling the light emitting devices. Each of the lighting unit and the NFC control unit include an NFC communication unit (e.g., an NFC antenna and related circuitry) are configured to communicate lighting system information and control parameters related to the light emitting devices, and are communicatively coupled by the respective NFC antennas in each unit. The NFC control unit can be integrated into a smartphone, tablet personal computer (PC), or any other suitable remote control device that includes an NFC communication unit. The NFC control unit includes a software application that enables the setting of one or more properties or parameters target light emitting devices of the remote lighting unit by transferring information regarding same between the lighting unit and the remote control unit through near field communication. Properties and functions controlled by the NFC control unit can include timers, spectral content, intensity, and other light emitting functions that are programmed by a user employing an application installed on the NFC control unit (e.g., the application includes a GUI or other user-friendly interface). With a broader application in some embodiments, other environmental factors can also be controlled such as water and/or air temperature, water salinity, air humidity, etc. to further enhance simulation of a given environment.

### Light Emitting Devices

The lighting system according to the present embodiments includes one or more individual light emitting devices. The light emitting devices may can be one or a combination of the following types of devices: a light emitting diode (LED); a phosphor converted LED; and organic LED (OLED); a LASER; a phosphor converted LASER; a colored fluorescent lamp; an incandescent light; a metal halide light; a filtered (colored) halogen lamp; a filtered (colored) high intensity discharge (HID) lamp; and/or a filtered (colored) ultra high performance (UHP) lamp. It should be appreciated that other suitable types of light emitting devices may be utilized as well, provided that said light emitting devices are controllable by the NFC control unit.

Of the different types of light emitting devices described herein, one example that is suitable for lighting systems such as aquariums or other marine environments is the LED, owing to its longevity, relatively low heat output, submergibility in liquids, and the wide variety of color ranges of same. LEDs are available in several different light emitting colors that correspond to different ranges of the electromagnetic spectrum. Certain color examples of LEDs include red, green, cyan, magenta, blue and white. Also, different color types of the LEDs can be combined with or without filters to produce different lighting effects such as, for example, warm white light, cold white light, red light, blue light, royal blue light, green light, ultraviolet (UV) light, and violet light. Thus, different colored LEDs or combinations of LEDs enable different lighting effects that can be applied to/in an aquarium or other marine environment lighting system to simulate natural lighting conditions and thus foster biological growth in same.

In addition to the benefits of LEDs discussed above, LEDs can also be controlled to turn on or off at different times, and the intensity of certain types of LEDs can be increased or decreased at faster or slower rates relative to other types of LEDs, thus creating a variety of different types of lighting effects that can be applied in an aquarium lighting system to simulate the myriad of natural lighting conditions discussed above.

Although specific examples and embodiments described herein focus on the example of standard LED lights, it should be appreciated that the lighting system is applicable to any suitable type of light emitting device, or combination of different types of light emitting devices. Moreover, although the example applications of LEDs to marine environments are illustrated in the embodiments described below, it should be appreciated that the LEDs or other types of light emitting devices may be applied in other environments such as home or office lighting systems, automobile lighting systems, indoor/outdoor holiday lighting systems, etc. Also, environmental control can be used to provide favorable habitats for other forms of terrestrial and marine life using other embodiments that include environmental factors that encourage animal and plant life of various types.

### Near Field Communication

As indicated above, the lighting systems of the present embodiments also include a near field communication (NFC) control unit. In general, near field communication is a set of standards for smartphones and similar devices to establish short-range wireless radio communication with each other by touching them together or bringing them into proximity. Generally, NFC operates within a range of several inches to several feet. Applications include contactless transactions, data exchange, and simplified setup of more complex communications such as Wi-Fi. Communication is also possible between an NFC device and an unpowered NFC chip, called a tag. NFC standards cover communications protocols and data exchange formats, and are based on existing radio-frequency identification (RFID) standards. In an example, NFC operates at 13.56 MHz on ISO/IEC 18000-3 air interface and at rates ranging from 106 kbit/s to 424 kbit/s. In examples where the NFC system communicates with a tag, the communication involves an initiator and a target. The initiator actively generates a radio frequency (RF) field that can power a passive target. This enables NFC targets to take very simple form factors such as tags, stickers, key fobs, or cards that do not require batteries. NFC peer-to-peer communication is also possible, provided both devices are powered, as discussed in several of the embodiments below.

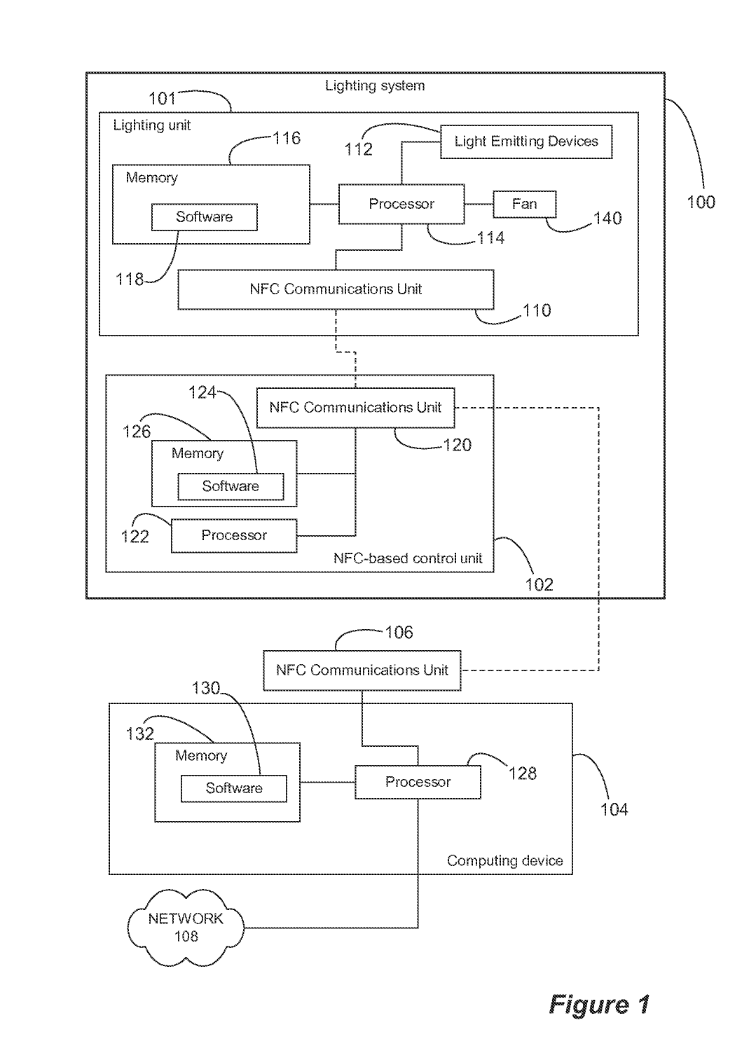

In one embodiment, as shown in FIG. 1, a lighting system 100 includes a lighting unit 101 and an NFC-based control unit 102 configured to transmit information to, and receive information from, the lighting unit 101.

The lighting unit 101 includes one more light emitting devices 112 (e.g., LEDs) operated at least partially under control of a processor 114. The processor 114 is connected to the light emitting devices 112, and is configured to transmit signals for controlling operational variables of the light emitting devices 112. The lighting unit 101 also includes a memory 116 connected to the processor 114, and at least one software module 118 that is also operable with the processor 114. In one example, the software module 118 is stored on the memory 116.

The lighting unit 101 further includes an NFC communication unit 110 connected to the processor 114. The NFC communication unit 110 is configured to send information to the processor 114, and to receive information from the processor 114 regarding the light emitting devices 112 (e.g., operating states of the light emitting devices and other device information). The processor 114, in cooperation with the software module 118 and memory 116, is configured to use information received by the NFC communication unit 110 from outside the lighting unit 101 (e.g., from the NFC-based control unit 102 that is discussed in further detail below) to control various operational conditions of the lighting elements 112. Moreover, the NFC communication unit 110, in cooperation with the processor 114 and the software module 118, is also configured to retrieve information from the memory 116 regarding operational conditions of the light emitting devices 112 or system information of the overall lighting system 100, and cause said information to be communicated outside of the lighting unit 101 to the NFC-based control unit 102 or other external NFC enabled device.

In one embodiment, the lighting system 100 includes only the lighting unit 101, where the lighting unit 101 is configured to operate in response to information that is received through near field communication channels (e.g., from the NFC-based control unit 102). In this embodiment, the information may come from any suitable NFC source, provided that the information is in a format that is usable by the lighting unit 101 to control at least one operational aspect of the light emitting devices.

In another embodiment, as shown in FIG. 1, the lighting system 100 further includes the NFC-based control unit 102. In this embodiment, the lighting system 100 includes a software application that is installed on the NFC-based control unit 102. For example, the software module may be an application that can be installed on an NFC-based control unit 102 that is in the form of a smartphone, a tablet PC, or any other suitable mobile computing device that can be positioned within NFC communication range of the NFC communication unit 110 of the lighting unit 101. The software module may be downloaded from an online applications store, or from any other suitable network location such as a corporate website. A user may then install the application on the NFC communication enabled device (e.g., the NFC-based control unit 102) to enable the NFC-based control unit 102 to communicate with the lighting unit 101.

As also shown in FIG. 1, in one embodiment, the NFC-based control unit 102 includes an NFC communication unit 120, a processor 122 connected to the NFC communication unit 120, at least one software 124 program, and a memory 126 connected to the processor 122. The software 124 may be stored on the memory. As indicated above, the NFC communication unit 120 of the NFC-based control unit 102 enables the control unit 102 to transmit information to the NFC communication unit 100, and to receive information from the NFC communication unit 110 of the lighting unit 101. As mentioned above, the NFC control unit is generally a portable computing device such as a smartphone, tablet PC, etc., that is equipped with an NFC interface. Thus, the NFC communication unit 110 of the lighting unit 101 communicates with the different NFC communication unit 120 of the NFC-based control unit 102.

In an embodiment, the NFC-based control unit 102 is configured to communicate via NFC communication protocols with both the lighting unit 101 as described above, as well as with another computing device 104 that is not directly connected with the lighting unit 101. In this embodiment, the NFC-based control unit 102 may be any suitable portable computing device, such as a mobile phone. As indicated above, the NFC-based control unit 102 includes a software 124 module that may be an application that a user has downloaded and installed on the device. In certain mobile applications, the functionality and complexity of the mobile application is simplified relative to other desktop computer applications, in order to improve ease of use for a user. Therefore, in this exemplary embodiment, the number of options for controlling the operational conditions of the light emitting devices 112 may be somewhat limited on the display device of the portable NFC-based control unit 102. The user can control more basic options, but is limited in the complexity to which certain lighting parameters can be programmed in order to maintain a relative simplicity in the mobile application interface. Thus, in this embodiment, the NFC-based control unit 102 further communicates with a suitable computing device 104 (e.g., a personal desktop computer), which has installed thereon a more advanced software module 130 for programming operational parameters of the lighting unit 101.

As shown in FIG. 1, the computing device 104 includes an NFC communication unit 106. This NFC communication unit 106 may have certain components similar to the other NFC communication units 110 and 120, such as the NFC antenna. In one embodiment, the NFC communication unit 106 is integral to the computing device 104. In another embodiment, the NFC communication unit 106 is a modular unit that can be connected to the computing device 104 via a universal serial bus (USB) port, or any other suitable connection port of the computing device 104. The computing device 104 further includes a processor 128, a memory 132, and a software module 130 that may be stored on the memory 132. The computing device 104 may also be connected to a network 108. Certain lighting parameters or lighting unit 101 operating schemes can be stored on the memory 132 of the computing device 104, and may be downloaded from the network 108.

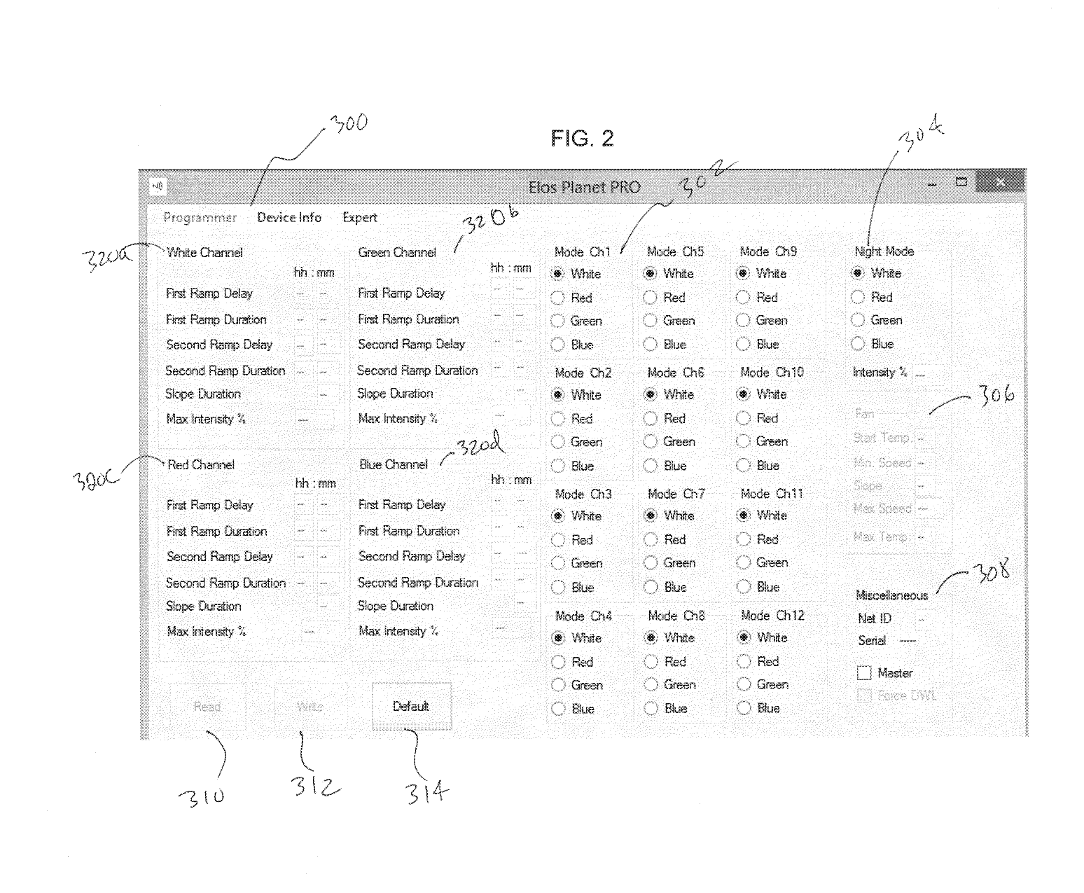

As shown in FIG. 2, which is one example of a user interface of the software module 130 for controlling the lighting unit 101, there are several operational variables that can be adjusted. For example, as shown in FIG. 2, the user interface 300 includes options for a white channel 320a, a green channel 320b, a red channel 320c and a blue channel 320d. Each of the channels include a first ramp delay, a first ramp duration, a second ramp delay, a second ramp duration, a slope duration, and a maximum intensity percentage value, for example. Each of the delays and durations can be set to a number of hours and minutes, and the intensity can be set to a certain percentage of a maximum intensity. The user interface 300 also includes twelve different mode channels 302 including radio selection buttons for white, red, green and blue light. The user interface also includes a night mode settings area 304 including radio selection buttons for white, red, green and blue light, as well as an intensity setting area. The user interface 300 also includes a fan settings area 306 for setting a start temperature, a minimum fan speed, a slope, a maximum speed, and a maximum temperature of a fan 140 that is included in the lighting unit 101. The user interface also includes a miscellaneous input area 308 which includes information regarding a network ID, a serial number of the lighting unit 101, and a master input.

The user interface 300 of the software 130 module of the computing device 104 further includes a read input 310, a write input 312, and a default input 314. The read input 310 initiates a read operation of information from the NFC-based control unit 102. The reading operation may include information regarding historical, current or future scheduled light emitting device 112 operational settings that are stored on the memory 126 of the NFC control unit. The data may also include system or device information of the lighting unit 101 that is stored on the memory 126 of the NFC-based control unit 102. The write input 312 enables customized user setting or preprogrammed settings (i.e., including the default settings indicated by the default input 314) to be sent from the computing device 104 to the NFC-based control unit 102 through NFC communication units 106 and 126, when the NFC-based control unit 102 is within NFC range of the computing device 104.

Although not shown in FIG. 2, the user interface 300 can also include one or more inputs related to the setting of time of sunrise, a duration of the day, an intensity of each channel (in this example, the light has twelve channels), duration of ramp-up and ramp-down, led configuration, mixing of lights and timings of same.

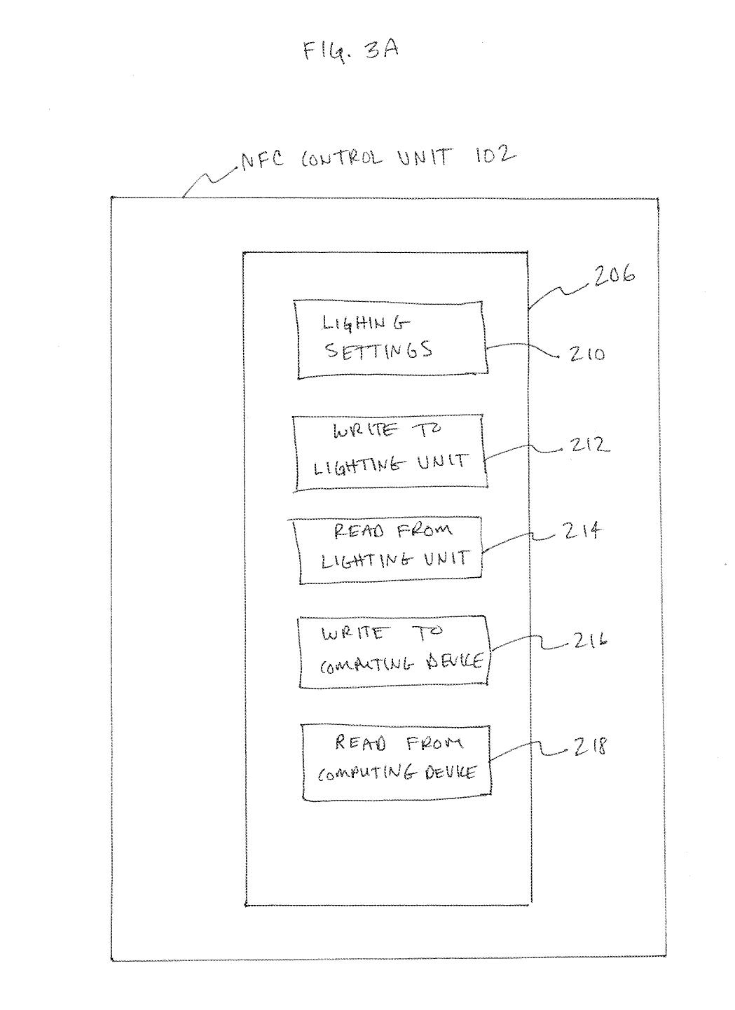

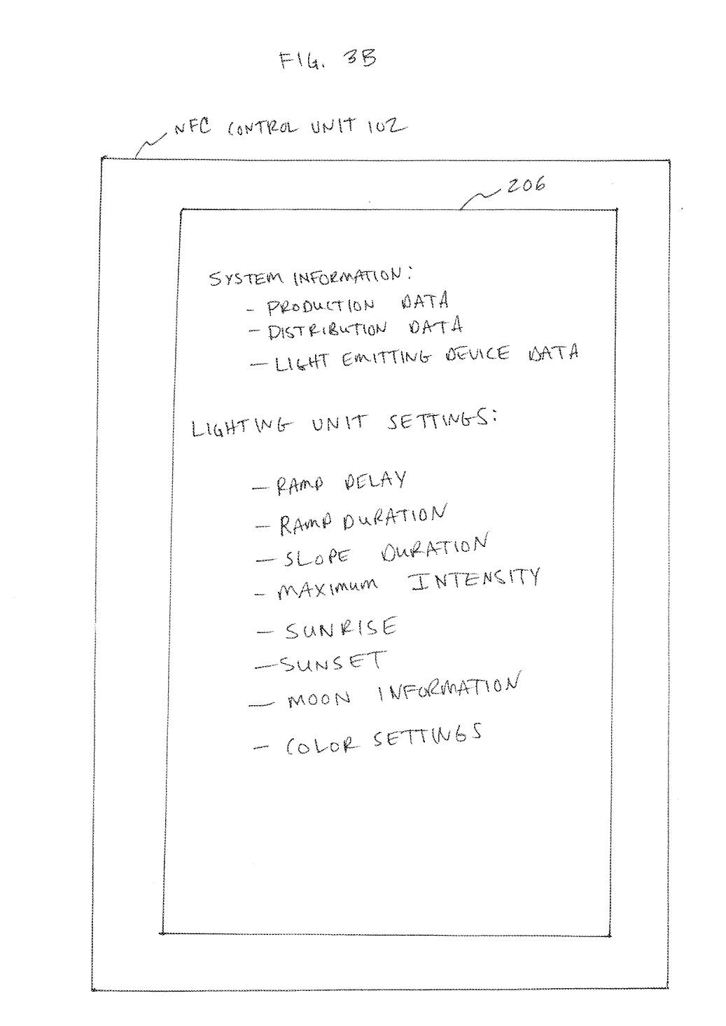

Once these setting are stored in the memory 126 of the NFC-based control unit 102, the NFC-based control unit 102 may then be moved from a first location that is in proximity to the computing device 104 to a location that is in proximity to the lighting unit 101. Then the settings that were initially set on the user interface 300 of the software module of the computing device 104 can be finally transferred to the lighting unit 101 via a second NFC information transfer from the NFC-based control unit 102 to the lighting unit 101. In this regard, a user is able to program relatively complicated lighting settings from the convenience of a personal computer, and then transfer these settings to the lighting unit via a two-step NFC transfer operation. For example, the user can select the write input 312 to transfer the information from the computing device 104 to the NFC control unit (e.g., a smartphone, control fob, etc.), and then once again select a write input 212 (as further discussed with regard to FIGS. 3A and 3B below) to transfer the information from the NFC-based control unit 102 to the lighting unit 101 itself. The same two step information transfer procedure can be used to transfer information from the lighting unit 101 to the computing device 108. In other embodiments a database or other storage location can provide preselected lighting and/or other environmental control options. For example, if a terrarium or aquarium owner wants to replicate a given location in the world (e.g., the Caribbean, a desert, Lake Ontario, etc.), that owner can in some cases consult a database that either provides settings for lighting and/or other environmental factors or provides a “packaged” set of settings/data that allow the user to transfer the settings to the control unit 102 or a computing device 104, then upload the settings/data to the lighting or other environmental control unit 101 for implementation. Such database listings could be based on latitude, longitude, date and/or time inputs. Other sources of information for settings can be considered in supplying information/data to users. Thus users can access a “library” of settings based on geographic location, time of year, desired plant/animal growth and behavior, etc.

In an embodiment, the NFC-based control unit 102 includes a display device 206 and a software application or module 124 that is operable with the processor 122 to display information to a user regarding the lighting unit 101. In an example where the NFC-based control unit 102 is an NFC enabled smartphone or computing tablet, a user may download a software application from an online application store or other location, and download the application onto the memory 126 of the NFC-based control unit 102. The software 124 application enables one or more graphical user interfaces displaying certain information regarding the lighting unit 101 and including several input areas on the display device. In an embodiment, the display device 206 is a touch screen device, and the input areas are operable upon contact with or proximity to a surface of the touch screen device. In another embodiment, the NFC-based control unit 102 includes physical input buttons. In the example shown in FIG. 3A, the graphical user interface of the software 124 module includes several input areas or buttons including, but not limited to, a lighting settings input 210, a write to lighting unit input 212, a read from lighting unit input 214, a write to PC input 216, and a read from PC input 218. The write to lighting unit input 212 initiates information transfer from the NFC-based control unit 102 to the lighting unit 101. The read from lighting unit input 214 initiates information transfer from the lighting unit 101 to the NFC-based control unit 102. The write to PC input 216 initiates information transfer from the NFC-based control unit 102 to the computing device 104. The read from PC input 218 initiates information transfer from the computing device 104 to the NFC-based control unit 102.

In one embodiment, when the lighting setting input 210 is selected, an expanded or modified graphical user interface is displayed, presenting the user with several control options. FIG. 3B shows one example of a graphical user interface displaying certain system information and a certain number of operational parameters or inputs relating to the lighting unit 101 and light emitting devices 112 thereof. It should be appreciated that the graphical user interface(s) may be presented in any suitable fashion other than that indicated in FIGS. 3A and 3B, and may include part or all of the operational inputs shown in the graphical user interface 300 of FIG. 2. It should also be appreciated that although the example is given above where the software 124 module that is installed on the NFC-based control unit 102 (e.g., a smartphone) has a simplified user interface 206 relative to the user interface 300 of the software 130 module installed on the computing device 104, in other examples, the user interface 206 of the NFC-based control unit 102 may also have the full functionality (or different/additional functionalities) when compared to same.

In another embodiment, one or more of the NFC-based control units 102 are in wireless communication with a central server (not illustrated) or controller that is connected for purposes of monitoring or controlling one or more different lighting units 101. In this example, the NFC-based control unit 102 communicates wirelessly (e.g., though a mobile telephone network) with the central server to store or retrieve certain operational parameters of the one or more lighting units 101. In this regard, a user may save several lighting schemes to a central server to retrieve same in the event of data loss at a local level in one or more of the memory 116 of the lighting unit 101, the memory 126 of the NFC-based control unit 102, or the memory 132 of the computing device 104. As an alternative method of storing data for backup (rather than directly from the NFC-based control unit 102 to the central server), the NFC-based control unit 102 can transfer information to the computing device 104, which can then transfer the information to the central server over the network 108.

Thus, by utilizing NFC-based control devices equipped with NFC interfaces (e.g., a mobile telephone), a user can transfer the parameters previously defined through the application (i.e., software 124) and subsequently stored on the NFC-based control unit 102 to the lighting unit 101 by simply positioning the NFC-based control device 102 in proximity of the NFC antenna on the lighting unit 101. In one example, a location of the NFC antenna on the NFC communication unit 110 can be shown by a visible mark on a particular portion of the lighting unit 101 so that a user can easily identify the approximate location of same. All the parameters will be transferred to the lighting unit 101 by simply pressing the “write button” on the software 124 application, as discussed above. To use the software on the PC (that offers more program options) the user will need to install the dedicated NFC-USB hardware interface on same. Similarly as is done when positioning the NFC-based control unit 102 (e.g., the phone) within communication range of the lighting unit 101, all the user needs to do is to simply position the interface of the NFC-based control unit 102 within NFC operational proximity to an NFC mark on the NFC-USB hardware interface (i.e., the NFC communication unit 106) and choose the “write option” on the software. Parameters stored on the NFC-based control unit 102 will be transferred to the lighting unit 101 or the computing device 104 depending on the input selected.

Similarly, information can likewise be read to the NFC-based control unit 102 from either of the lighting unit 101 or the computing device 108. A user can read several parameters stored in the lighting unit such as: production data including production date, serial number, verified by information, and batch number; distribution parameters such as the name of the customer, the date of sale, and the sale price; and lamp parameter such as timer information, lighting unit 101 configuration, fan configuration, etc. On the NFC-based control unit 102 that is equipped with the NFC interface, the user can read the parameters stored in the lighting unit 101 by simply positioning the NFC-based control unit 102 (e.g., a smartphone) within operational proximity to the NFC antenna of the NFC communication unit 110, shown, for example, by a visible mark on the bottom of the lighting unit 101. All the parameters will be transferred to the application or software 124 of the NFC-based control unit 102 by pressing the “read button” input on the software 124 application. To use the software 130 on the PC (that offers more program options) the user will need to install the dedicated NFC-USB hardware interface (i.e., the NFC communication unit 106) on same, as discussed above. Similarly as is done with the NFC-based control unit 102 (e.g., the phone), all the user needs to do is to position the interface (i.e., the NFC communication unit 120) close to the NFC mark on the NFC-USB hardware interface and choose the “read option” on the software. Parameters stored on the lighting unit 101 or the computing device 104 will be transferred to the NFC-based control unit 102 depending on the input selected.

Accordingly, in the described embodiments, it is possible to transfer data between the lighting system and the software application in a simple way. In another example of information transfer, the management of the warranty for the lighting unit can be simplified. In further example, the stock management of the lighting units can be performed. In a further example, the personalization management of the lighting unit can be modified based on the specific needs of different countries.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A lighting unit comprising:
a plurality of light emitting devices; and
a near field communication unit communicatively coupled with the light emitting devices,
wherein the near field communication unit is operable to receive lighting unit information from a remote control unit via near field communication, and to transmit lighting unit information to the remote control unit via near field communication.

2. The lighting unit according to claim 1, wherein the light emitting devices are light emitting diodes.

3. The lighting unit according to claim 1, wherein the lighting unit information includes control parameters for controlling the operation of at least one of the light emitting devices.

4. The lighting unit according to claim 1, wherein the lighting unit information includes at least one selected from the group consisting of:
lighting unit production data including at least one of a serial number, a manufacturing date, inspection information, and a production batch number;
lighting unit distribution data including at least one of a customer name, a date of sale, and a sale price; and
lighting emitting device parameters including at least one of light emitting device configuration, and light emitting device timing control information.

5. The lighting unit according to claim 1, further comprising:
a memory storing at least a software program including executable instructions; and
a processor configured to execute the instructions of the software program to cause at least one of:
reading lighting unit information stored on the memory, and causing the lighting unit information to be transferred from the near field communication unit to the remote control unit;
storing the lighting unit information received from the remote control unit on the memory; and
setting an operating parameter of at least one of the light emitting devices based on the lighting information received from the remote control unit, or based on lighting information that has been stored on the memory.

6. The lighting unit according to claim 1, wherein the lighting unit information includes parameters defining different operating states that can be applied to one or more of the light emitting devices.

7. The lighting unit according to claim 6, wherein the operating states of the light emitting devices include at least one selected from the group consisting of an on/off state, a light emission intensity level, and a rate of change of the light emission intensity level.

8. The lighting unit according to claim 7, wherein the lighting unit information further includes a timing schedule for changing one or more of the operating states with regard to at least one of the light emitting devices.

9. A lighting system comprising:
a lighting unit including
a plurality of light emitting devices, and
a first near field communication unit communicatively coupled with the light emitting devices; and
a remote control unit including a second near field communication unit and a non-transitory computer-readable medium storing executable instructions that when executed by a processor cause said remote control unit to perform at least one of the steps of
causing first lighting system information to be sent wirelessly via near field communication from the second near field communication unit to the first near field communication unit, and
processing second lighting system information that is received wirelessly via near field communication by the second near field communication unit and that was sent from the first near field communication unit.

10. An environmental control unit comprising:
a plurality of environmental factor control devices; and
a near field communication unit communicatively coupled with the plurality of environmental factor control devices,
wherein the near field communication unit is operable to receive environmental control information from a remote control unit via near field communication, and to transmit environmental control information to the remote control unit via near field communication.

11. The environmental control unit of claim 11 wherein the plurality of environmental factor control devices include one or more of the following: a lighting unit, an air temperature control unit, a water temperature control unit, a humidity control unit, a salinity control unit.

12. The environmental control unit of claim 11 wherein the remote control unit provides a simpler user interface for setting one or more parameters used in controlling the plurality of environmental factor control devices.
